(19) United States
(12) Patent Application Publication
(10) Pub. No.: US 2004/0068852 A1
(43) Pub. Date: Apr. 15, 2004

(54) Wheel helper

(76) Inventor: Enos Nolan, Allentown, PA (US)

Correspondence Address: ENOS F.C. NOLAN, 428 N. FULTON ST., ALLENTOWN, PA, 18102, US

(21) Appl. No.: 10/270,402

(22) Filed: Oct. 15, 2002

(51) Int. Cl. B25B 27/14

(52) U.S. Cl. 29/273

(57) ABSTRACT

The Wheel Helper's whole purpose is to greatly reduce the amount of effort that it takes in the handling of a spare tire in the process of fixing a flat on a car or light truck. This tool can save a motorist time and money by not having to call and wait for a tow truck. It enables the person to be able to quickly get this job done and be on their way without a great amount of exertion. One of the hardest parts of changing a tire is holding the wheel in place while aligning the holes with the lugs. The Wheel Helper lifts and holds the wheel in place so that the holes on the rim and the lugs on the axle can be aligned.

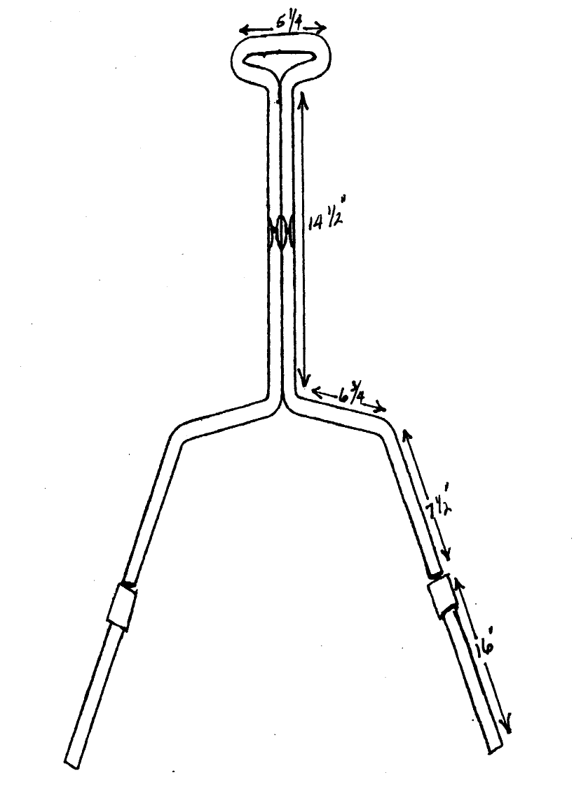

### BACKGROUND

Changing the tire of a car or light truck, whether at home or in an emergency situation out on the road, can be quite a physical process When a spare tire is to be mounted on a vehicle, the Wheel Helper, helps to secure the wheel and lift it up to the hub and studs for easy alignment.

### DETAILED DESCRIPTION

The Wheel Helper is constructed of 69.5 inches of 30-gauge mild steel that is bent into several sections. Firstly, to form a handle, next the main shaft of the tool, and thirdly, the working body of the Wheel Helper. To better facilitate easy storage and portability of the tool, the lower portion of the main body is removable.

To make the prototype, exact measurements of steel is heated and bent into the forms of handle, main shaft, and working body as mentioned above.

The Wheel Helper is of simple engineering design and requires only for the would-be maker to observe the drawings along with the dimensioning of the drawings in order to construct it.

The wheel to be mounted on to the vehicle is positioned between the working body or “The fork” of the Wheel Helper. By raising the handle of the Wheel Helper, the wheel is lifted into position to be installed on to the hub.

1. I claim the entire tool which I named the Wheel Helper, that can be used to greatly reduce the amount of effort needed to change a tire, in the event of a flat on an automobile or light truck, as my original invention. No part of this idea was taken from any other tool now in production. In fact, I do not know of any such tool in existence.
